(19) United States
(12) Patent Application Publication
(10) Pub. No.: US 2004/0128883 A1
(43) Pub. Date: Jul. 8, 2004

(54) Reversible insignia tab

(75) Inventor: Jack Greenberg, Stamford, CT (US)

Correspondence Address: OLIFF & BERRIDGE, PLC, P.O. BOX 19928, ALEXANDRIA, VA, 22320, US

(73) Assignee: EVEREADY EMBROIDERY INC., Jersey City, NJ

(21) Appl. No.: 10/639,535

(22) Filed: Aug. 13, 2003

Related U.S. Application Data
(60) Provisional application No. 60/423,386, filed on Nov. 4, 2002.

(51) Int. Cl. G09F 21/02

(52) U.S. Cl. 40/586

(57) ABSTRACT

A reversible insignia tab for use on the epaulets of uniforms including a first portion having a first color scheme and a second portion having a second color scheme, thereby allowing a wearer of the uniform to easily display either the first color scheme or the second color scheme using the same insignia tab.

This non-provisional application claims the benefit of U.S. Provisional Application 60/423,386 filed Nov. 4, 2002.

### BACKGROUND OF THE INVENTION

1. Field of Invention

This invention relates to tabs for displaying insignia worn on clothing or military uniforms.

2. Description of Related Art

The use of tabs on clothing and in particular, military uniforms is well known. Typically, in the case of military uniforms, a flap of material located on the shoulder portion of a garment or outer portion of a jacket (i.e., an epaulet) may be sewn to the garment at one end and may have a button, snap or other fastening device at the other end. A tube shaped tab having an insignia or rank attached or embroidered thereto may be slid over the flap. The flap may then be reattached to the garment by the button, snap or other fastening device to secure the tab to the flap. The tab itself may be of cloth, or any other flexible material. These tabs allow rank insignia or other types of insignia to be attached to an outer garment without actually having to embroider or otherwise attach the insignia directly to the garment. In the case of metal rank or insignia, the tabs remove the necessity to pierce the garment itself in order to display the rank or insignia.

In the military, in addition to displaying rank, tabs may be used to signify the status of a particular soldier. For instance, different color tabs may be used to signify that a particular soldier is in a leadership position such as squad leader, platoon leader, etc. In the case of Battle Dress Uniforms (BDU's), tabs having colors that are consistent with a particular camouflage pattern must be used. For instance, if a woodland or jungle type camouflage pattern is worn, green tabs may be used. If a desert camouflage pattern is worn, tan or yellow tabs may be used. When it becomes necessary to change from, for instance, a jungle or woodland type BDU to a desert type BDU, the corresponding tabs that are used with the uniform must also be obtained and changed in order to properly display rank or insignia.

### SUMMARY OF THE INVENTION

This invention thus allows a user to change uniforms, for instance, from woodland BDU's to desert BDU's without having to use a new tab for displaying rank or insignia. In a combat environment it is essential that a soldier be properly camouflaged in order to avoid detection. Thus, rank or insignia that is subdued in color or appearance may be generally worn. When rank is displayed on a tab, it is essential that the tab be of a color that is consistent with the camouflage material, or the individual soldier may be in danger of being detected by virtue of the different color tab worn with the uniform.

With this invention, the tab is reversible, having one color on a first side, and another color on a second, opposite side. The reversible tab may merely be removed from a flap of material on one uniform, reversed and then placed on the appropriate second uniform, thus, displaying the appropriate color tab along with the rank or insignia.

In one exemplary embodiment, a tab is provided that has a different color on one side than that of the other side. When switching uniforms, the wearer merely reverses the tab to the side that has a color that is consistent with the uniform being worn. For instance, in the case of changing from woodland BDU's to desert BDU's, a soldier would merely remove the tab and flip it to the side having the appropriate color, i.e., green or tan. In various exemplary embodiments, the insignia or rank on the tab may be embroidered onto the tab. In this case, the rank would be embroidered on both sides of the tab such that each side of the tab would have rank sewn on to the appropriate color portion matching that particular uniform.

In other exemplary embodiments, the tab may be separable in the center portion by hook-and-loop strips (such as Velcro™ strips), snaps, zippers, magnets, or clips. The individual would remove the tab utilizing the Velcro strips or snaps and reverse it such that the inside of the tab would now be showing. In this case, the material on the inside of the tab would have a different color than the material on the outside of the tab and the appropriate color material may be chosen in conjunction with the uniform that is being worn. As with the previous embodiment, the rank or insignia may be sewn on the inside and outside of the tab such that when the appropriate color is displayed the rank is also displayed. In the case where metal insignia are used, the insignia would be removed and replaced once the tab has been turned inside out.

While these tabs may be reversible to coincide with the particular uniform being worn, the tabs may also be reversed to display different colors signifying the status of a particular soldier. For instance, during military exercises these tabs may be reversed to signify that a particular soldier is a member of the opposing force during a training exercise. In this case, the tab may be of a bright color such that it is easily distinguishable from a distance. When these particular soldiers are finished with a training exercise, they would merely reverse the tab back to the corresponding color of their uniforms. In addition, the reversible tabs could be used to signify other aspects of a particular soldier. For instance, they could be used to signify that the individual soldier is not participating in the exercise and is merely an observer, controller, or that the individual soldier is a medic or a member of another noncombat arms branch.

These and other features and advantages of this invention are described in or are apparent from the following detailed description of the preferred embodiments.

### BRIEF DESCRIPTION OF THE DRAWINGS

The invention will be described with reference to the accompanying drawings, in which like elements are labeled with like numbers and in which:

FIG. 1 shows a tab of the prior art;

FIG. 2 shows the tab of the prior art as displayed on a flap of clothing;

FIG. 3 shows one embodiment of the tab of this invention;

FIG. 4 is another view of the tab of FIG. 3;

FIG. 5 is another exemplary embodiment of the tab of this invention; and

FIG. 6 is a view of the tab of FIG. 5 as attached to a flap of clothing.

### DETAILED DESCRIPTION OF PREFERRED EMBODIMENTS

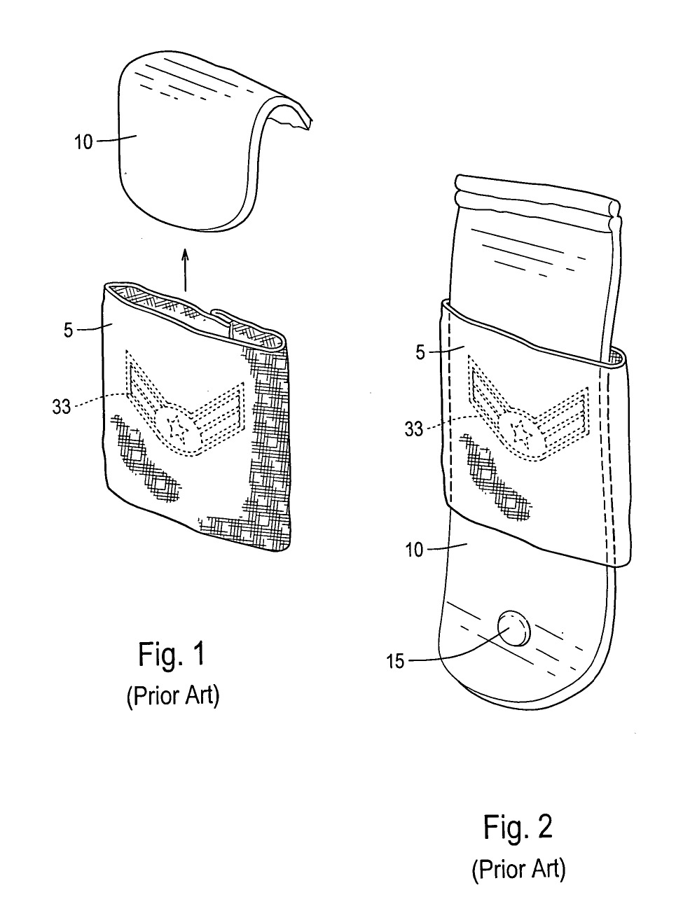

FIG. 1 shows a tab of the prior art. The tabs essentially consist of a loop of clothing that is sewn in the rear. The rank or insignia 33 may be embroidered or sewn on the front of the tab 5. The tab 5 is then slid onto the flap 10. As discussed previously, when a uniform is changed to one of a different color, a new tab having the appropriate rank must be fitted on to the flap 10. Thus, each time a different color uniform is worn, a tab 5 having the appropriate color must be found and placed on the flap 10. The flap 10 may be secured to the garment by a snap or button 15 such that the tab 5 is not lost. FIG. 2 shows the tab 5 in place on the flap 10. As stated previously, once the tab 5 is in place on the flap 10, a snap or button 15 would be fastened to keep the tab 5 in place.

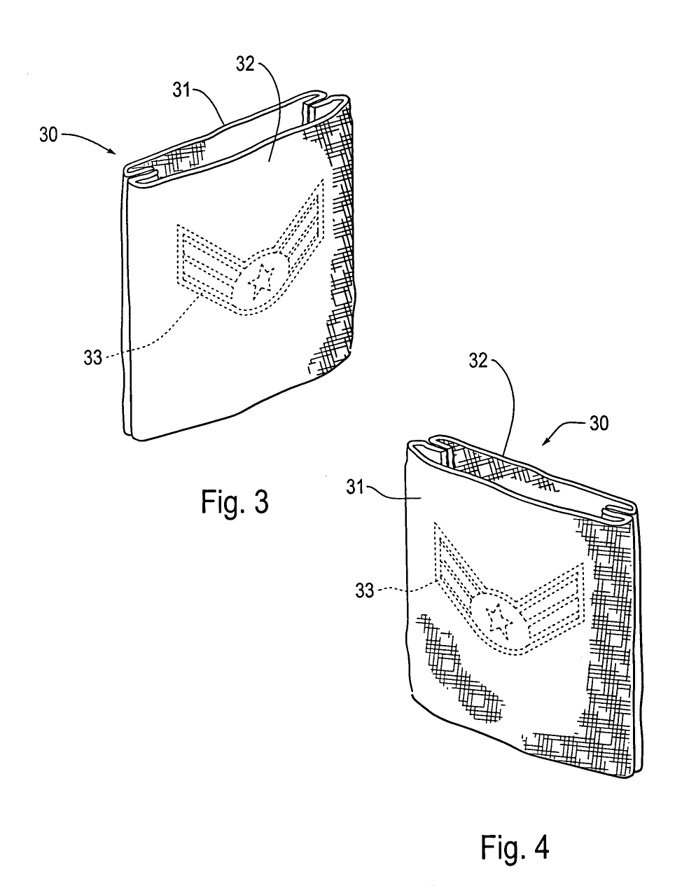

FIG. 3 is an exemplary embodiment of the tab of this invention having rank or insignia 33 located on both sides of the reversible tab 30. The tab 30 includes two sections of material 31, 32 that are sewn together to form the reversible tab 30. In this embodiment, the two sections of material 31, 32 would be of different colors corresponding to a particular status or a particular uniform being worn at the time. For example, the section of material 32 may correspond to a woodland type BDU, and section of material 31 could correspond to a desert or jungle type BDU. FIG. 4 is another perspective view of the embodiment shown in FIG. 3.

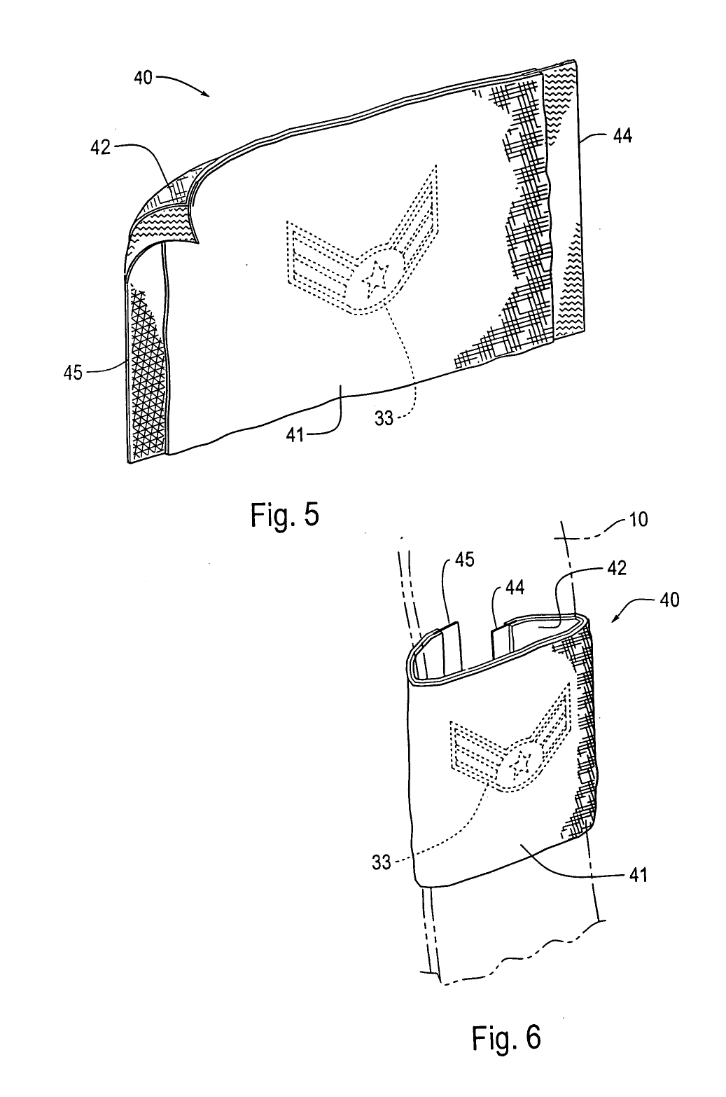

FIG. 5 shows another embodiment of the tab of this invention. In this embodiment the tab 40 has corresponding hook-and-loop strips 44, 45 located on opposite ends of the tab. The tab 40 also has different color sections of material 41, 42 located on opposite sides of the tab 40 such that the tab 40 is reversible, based on the uniform being worn. For instance, one side of the tab may be tan in color for use with the desert camouflage pattern, while the other side of the tab may be dark green for use with the woodland pattern BDU's. When changing a uniform, a soldier would merely unfasten the hook-and-loop strips 45, 44 and reverse the tab to the appropriate color. As with the previous embodiments, the rank or insignia may be sewn on the individual tab or, in the case of metal insignia, may be pinned through the tab.

FIG. 6 shows the tab 40 of FIG. 5 in place on a flap 10. In this case, the tab 40 is secured on the flap 10 by folding it around the flap 10 and fastening the hook-and-loop strips 45, 44 on the back side of the tab. In this embodiment, the tab may be removed and replaced without having to unbutton or unsnap the flap 10 from the garment.

While this invention has been described in conjunction with the specific embodiments outlined above, it is evident that many alternatives, modifications and variations will be apparent to those skilled in the art. Accordingly, the preferred embodiments of the invention, as set forth above, are intended to be illustrative, not limiting. Various changes may be made without departing from the spirit and scope of the invention.

What is claimed is:

1. A reversible insignia tab comprising:
a first portion comprising a first color scheme; and
a second portion comprising a second color scheme, wherein the first color scheme is different from the second color scheme and only one of the first portion or the second portion is exposed when the insignia tab is placed on a uniform.

2. The reversible insignia tab of claim 1, further comprising:
a first insignia fixed on the first portion; and
a second insignia fixed on the second portion.

3. The reversible insignia tab of claim 2, wherein the first insignia is different from the second insignia.

4. The reversible insignia tab of claim 1, wherein the first portion and the second portion are connected to form a flattened loop, the first color scheme exposed from an outside of a first side of the flattened loop and the second color scheme exposed from an outside of a second side of the flattened loop.

5. The reversible insignia tab of claim 1, further comprising a fastener, wherein the first portion and the second portion form a flat elongated strip, the first color scheme is exposed from one side of the strip, the second color scheme is exposed from the other side of the strip, a first element of the fastener is fixed to one end of the strip, and a second element of the fastener is connected to an opposite end of the strip, the first and second elements of the fastener being connectable to one another.

6. A reversible insignia tab comprising:
a first portion comprising a first insignia; and
a second portion comprising a second insignia, wherein the first insignia is different from the second insignia and only one of the first portion or the second portion is exposed when the insignia tab is placed on a uniform.

7. The reversible insignia tab of claim 6, wherein the first portion and the second portion are connected to form a flattened loop, the first insignia exposed from an outside of a first side of the flattened loop and the second insignia exposed from an outside of a second side of the flattened loop.

8. The reversible insignia tab of claim 1, further comprising a fastener, wherein the first portion and the second portion are on opposite sides of a flat elongated strip, the first insignia is exposed from one side of the strip, the second insignia is exposed from the other side of the strip, a first element of the fastener is fixed to one end of the strip, and a second element of the fastener is connected to an opposite end of the strip, the first and second elements of the fastener being connectable to one another.
